(19) United States
(12) Patent Application Publication
(10) Pub. No.: US 2008/0124441 A1
(43) Pub. Date: May 29, 2008

(54) Method of manufacturing pipe-burger

(76) Inventor: Shlomy Weingarten, Las Vegas, NV (US)

Correspondence Address: Raymond Y. Chan, Suite 128, 108 N. Ynez Avenue, Monterey Park, CA, 91754, US

(21) Appl. No.: 11/604,073

(22) Filed: Nov. 24, 2006

(51) Int. Cl. A23L 1/317; A23P 1/12; A23L 1/01; A23L 1/325; A23L 3/34; A23L 1/31; A23L 1/315

(52) U.S. Cl. 426/541; 426/513; 426/404; 426/646; 426/643; 426/644; 426/647

(57) ABSTRACT

A method of manufacturing a pipe-burger includes the steps of: (a) mixing a predetermined amount of texture-rich meat with flavoring ingredients to form a burger meat; (b) extruding the burger meat into a tubular pipe mold to form an elongated pipe-burger meat in a skinless manner; (c) cooking the elongated pip-burger meat to form a cooked pipe-burger meat with coarse fiber; (d) providing a burger bun having an elongated burger cavity which is corresponding to the cooked pipe-burger meat; and (e) disposing the cooked pipe-burger meat into the burger cavity of the burger bread to form a burger product.

### BACKGROUND OF THE PRESENT INVENTION

1. Field of Invention

The present invention relates to a burger, and more particularly to a method of manufacturing a pipe-burger which is easier to consume, to be served, to chew, and is healthier than conventional burgers.

2. Description of Related Arts

A conventional burger usually comprises a burger bun having two pieces of burger bread, and a piece of burger meat sandwiched between the two pieces of burger bread. Very often, when the burger is made by restaurants, a considerable amount of other accessories, such as a wide variety of sources, pickles, vegetables, bacons, and the likes will also be lavishly sandwiched into the burger bun so as to make the entire burger extremely attractive for customers.

There are several problems for conventional burgers, both from the customers' perspective and from the manufacturers' perspective. From the customers' perspective, it is well-known that conventional burgers are extremely high in fat content, and extremely low in fiber content. The combination of these nutrient profiles results in the claim that conventional burgers are extremely unhealthy, often or even regular consumptions of which may result in many coronary and other diseases. From these facts, it is claimed that fast food is usually equivalent to junk food.

Second, virtually all conventional burgers have two dimensions (i.e. a flat dimension) and are circular in shape. So when the burger bun has been filled by a considerable amount of food, the customer will feel that it very inconvenient to eat, in the sense that during the course of eating the burger, there exists literal movement between the burger bread and the burger meat and all the other ingredients stuffed in the burger bun. The result is that the burger meat and the other ingredients will be slowly squeezed out of the burger bun. In such scenario, the customer may need to manually hold the squeezed meat and other ingredients by both hands in order to prevent them from falling onto the table by which the customer eats the burger. In worse situation, the squeezed meat and other ingredients fall onto the table and make the entire environment very messy.

There exist alternatives for burgers. For example, hot dogs are smaller in size than burgers, and there are fewer ingredients stuffed in a hot dog bun so that it is easier for consumers to eat hot dogs rather than fully-stuffed burgers. However, there exist other problems for these alternatives. An obvious problem for these alternatives, such as hot dogs, is that their nutrient content is by no means healthier than their burgers counterparts. Take hot dog for example, a regular hot dog usually contains a sausage filled within a hot dog bun. A regular sausage usually contains a large amount of fat and very small amount of fiber in its nutrition content. Thus, although hot dogs are good alternatives to burgers in terms of ease of eating, they are not good alternatives in terms of nutrition content.

Moreover, since hot dogs usually contains only one sausage in the hot dog bun, it is likely that one may not feel full with just eating one hot dog. In fact, many people treat hot dogs as a kind snack instead of a full meal. The story is different, however, for burgers. Most people treat burger, due to its huge size and lavish content, as a full meal. In fact, many people, especially women, simply cannot finish a burger in a single meal.

Finally, for almost all hot dog sausages, there exists a predetermined textile formed as a casing as a skin of the relevant hot dog sausage. This skin layer makes the entire hot dog to be more chewable in the sense that the sausage will seem to have more meat than it actually has. Thus, for almost all conventional hot dogs, the manufacturers often use some sorts of artificial skin to pretend a tasty and chewable feeling of what is actually to be an unhealthy and meatless junk food.

### SUMMARY OF THE PRESENT INVENTION

A main object of the present invention is to provide a method of manufacturing a pipe-burger which is easier to chew, and healthier than conventional burgers.

Another object of the present invention is to provide a method of manufacturing a pipe-burger which comprises a texture-rich burger meat filled with coarse fiber for substantially enhancing the nutrition value and ease of eating as compared with traditional burgers.

Another object of the present invention is to provide a method of manufacturing a pipe-burger which has an elongated size with a predetermined cross-sectional diameter designed for optimal ease of eating of the pipe-burger.

Another object of the present invention is to provide a method of manufacturing a pipe-burger, which is capable of being served as fast food having healthy content. Thus, the present invention is adapted to act as a paradigm that fast food is not equivalent to junk food.

Another object of the present invention is to provide a method of manufacturing a pipe-burger which is simple and economical to implement so as to minimize the manufacturing cost and maximize the widespread application of the present invention.

Accordingly, in order to accomplish the above objects, the present invention provides a method of a method of manufacturing a pipe-burger, comprising the steps of:

(a) mixing a predetermined amount of texture-rich meat with flavoring ingredient to form a burger meat;

(b) extruding the burger meat into a tubular pipe mold to form an elongated pipe-burger meat in a skinless manner;

(c) cooking the elongated pip-burger meat to form a cooked pipe-burger meat with coarse fiber;

(d) providing a burger bun having an elongated burger cavity which is corresponding to the cooked pipe-burger meat; and

(e) disposing the cooked pipe-burger meat into the burger cavity of the burger bread to form a burger product.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a pipe-burger according to a preferred embodiment of the present invention.

FIG. 2 is a method of manufacturing a pipe-burger according to the above preferred embodiment of the present invention.

### DETAILED DESCRIPTION OF THE PREFERRED EMBODIMENT

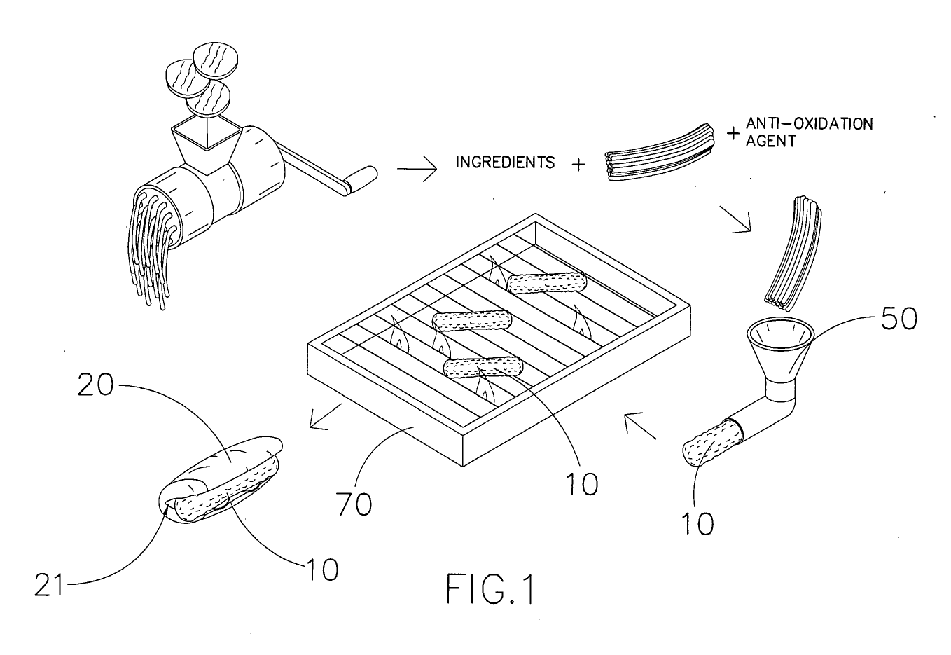

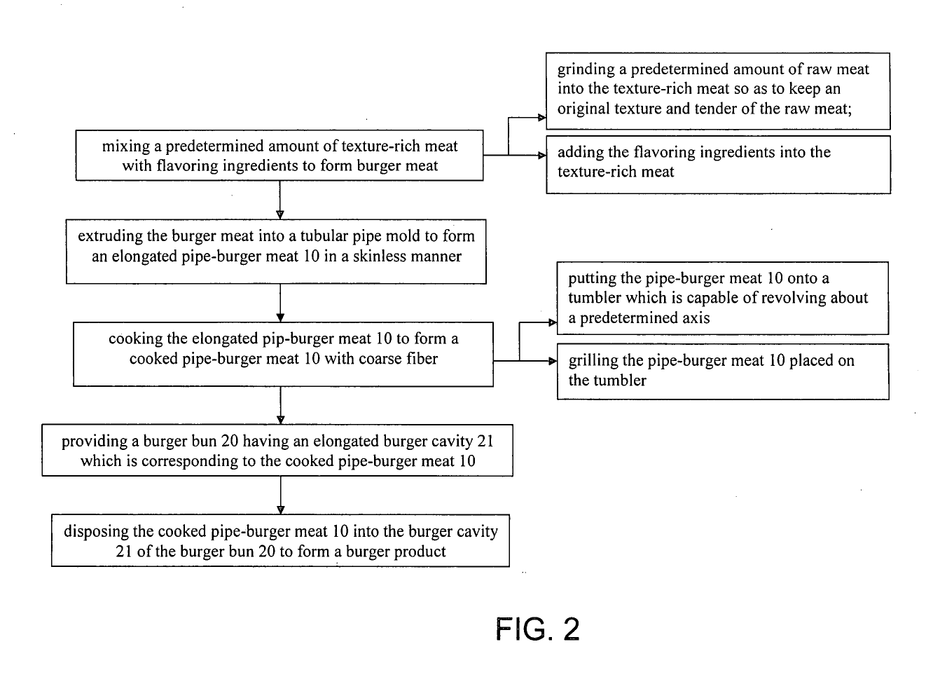

Referring to FIG. 1 to FIG. 2 of the drawings, a method of manufacturing a pipe-burger according to a preferred embodiment of the present invention is illustrated, in which the method comprises the steps of:

(a) mixing a predetermined amount of texture-rich meat with flavoring ingredients to form burger meat by a tumbler;

(b) extruding the burger meat into a tubular pipe mold 50 to form an elongated pipe-burger meat 10 in a skinless manner;

(c) cooking the elongated pip-burger meat 10 to form a cooked pipe-burger meat 10 with coarse fiber;

(d) providing a burger bun 20 having an elongated burger cavity 21 which is corresponding to the cooked pipe-burger meat 10; and

(e) disposing the cooked pipe-burger meat 10 into the burger cavity 21 of the burger bun 20 to form a burger product.

According to the preferred embodiment of the present invention, step (a) comprises the steps of:

(a.1) grinding a predetermined amount of raw meat into the texture-rich meat so as to keep an original texture and tender of the raw meat; and

(a.2) adding the flavoring ingredients into the texture-rich meat for enhancing a taste and nutrition value of the cooked pipe-burger meat 10, wherein the flavoring ingredients comprises, but not limited to, natural spice, salt and natural juice.

It is thus worth mentioning that the flavoring ingredients can be a number of extremely diverse sorts of ingredients. Thus, as mentioned earlier, the flavoring ingredients can comprises but not limited to, a predetermined amount of salt, a predetermined amount of juice having rich fiber content (such as prune juice, carrot juice etc.), and a predetermined amount of dry spice. Many other flavoring ingredients may also be added according to different circumstances in which the pipe-burger is to be consumed. Moreover, the kind of meat used to manufacture the pipe-burger meat 10 is selected from the group of beef, pork, chicken, turkey, salmon and green meat (made of vegetable and soy bean). In other words, there exists a wide variety of pipe-burger meat 10.

Step (a) further comprises a preserving step (a.3) of mixing a predetermined amount of natural anti-oxidation agent as a preservative agent of the pipe-burger meat 10 in a healthier manner. Thus, the present invention does not utilize any artificial preservative agent. Instead, the pipe-burger meat 10 contains natural anti-oxidation agent as preservatives. The anti-oxidation agent is preferably embodied as prune juice or powder. Step (a.3) is preferably performed in the tumbler.

In step (b), the burger meat 10 is directly extruded into the tubular pipe mold 50 to retain the pipe-burger meat in an elongated structure so as to eliminate a casing for the burger meat stuffing thereinto.

It is important to point out that the pre-designed mold 50 is adapted to form a shape of the pipe-burger meat 10 corresponding with the elongated shape of the burger bun 20. Moreover, there is no artificial skin (such as the above-mentioned coarse fiber textile) attached on an outer surface of the pipe-burger meat 10, in that the very purpose of having such a skin has been eliminated. In other words, because the entire pipe-burger meat 10 has substantial meat content, there is no need to attach an artificial skin, such as the above-mentioned coarse fiber textile, on the pipe-burger meat 10 in order to make it more tasty and chewable, i.e. there is no need to pretend that there is substantial content of meat in the burger-pipe meat 10 because there is actually a substantial content of meat in the pipe-burger meat 10.

Step (c) comprises the steps of:

(c.1) putting the pipe-burger meat 10 onto a cooker 70; and

(c.2) grilling the pipe-burger meat 10 placed on the cooker 70 for cooking the pipe-burger meat 10 into the cooked pipe-burger meat 10, wherein the pipe-burger meat 10 has an outer coarse surface when it has been grilled.

According to the preferred embodiment of the present invention, in step (c), the pipe-burger meat 10 is grilled to form the cooked pipe-burger meat 10, having a diameter with a range from 0.5 to 2 inches, and to keep the coarse fiber thereof.

Note that the cooked pipe-burger meat 10 does not have any artificial skin (such as the coarse-fiber textile) attached onto its outer surface, and the resulting cooked pipe-burger meat 10 contains all the favoring ingredients as stated in step (a).

In order to preserve the pipe-burger for a longer period of time, the method of manufacturing a pipe-burger further comprises a step, after step (b), the steps of:

(b.1) pre-cooking the pipe-burger meat 10 for safety purpose;

(b.2) vacuum-packing the pipe-burger meat 10 in a sealing bag to eliminate bacteria and germs in the vicinity of the pipe-burger meat 10; and

(b.3) keeping the pipe-burger meat 10 in a sealing bag under a predetermined temperature to keep a freshness of the pipe-burger meat 10. It is expected that the burger product, having been properly vacuumed, can be kept in a refrigerator for approximately ninety days.

As a reference, the pipe-burger is expected to have the following nutrition values:

| | Pipe-Burger Meat (Beef | | Pipe-Burger Meat | |
|---|---|---|---|---|
| Nutrition Value | Griller) | | (Chicken Griller) | |
| Calories | 240 | | 120 | |
| Calories from fat | 180 | | 45 | |
| Fat | 18 | g | 6 | g |
| Saturated fat | 9 | g | 1.5 | g |
| Cholesterol | 45 | mg | 45 | mg |
| Sodium | 600 | mg | 600 | mg |
| Carbohydrates | 0 | g | 0 | g |
| Fiber | 0 | g | 0 | g |
| Protein | 15 | g | 18 | g |

Thus, one may appreciate that the pipe-burger of the present invention promotes a healthier eating habit for fellow burger lovers. In particular, the present invention provides a method of manufacturing a pipe-burger which does not contain artificially composed ingredients, chemical preservatives and monosodium glutamate (MSG). As a result, it is expected the present invention will turn what has traditionally been regarded as junk food into a healthy and tasty food product fitting all kinds of burgers loves, including fellow vegetarians.

In light of the above, it is important to point out that the present invention also discloses a pipe-burger for a burger product, comprising the elongated pipe-burger meat 10 in a skinless manner, wherein the pipe-burger meat 10, having a diameter corresponding to a mouth size of an eater, is made of texture-rich meat having coarse fiber with flavoring ingredients. Accordingly, the pip-burger is manufactured by a process comprising the above mentioned steps of:

(a) mixing a predetermined amount of texture-rich meat with flavoring ingredients to form burger meat by a tumbler;

(b) extruding the burger meat into a tubular pipe mold 50 to form an elongated pipe-burger meat 10 in a skinless manner;

(c) cooking the elongated pip-burger meat 10 to form a cooked pipe-burger meat 10 with coarse fiber;

(d) providing a burger bun 20 having an elongated burger cavity 21 which is corresponding to the cooked pipe-burger meat 10; and

(e) disposing the cooked pipe-burger meat 10 into the burger cavity 21 of the burger bun 20 to form a burger product.

It is worth mentioning that the pipe-burger has different sizes to fit the open-mouth size of the eater. In other words, the outer circumferential size of the burger bun 20 with the pipe-burger meat 10 at the burger cavity 21 is smaller than the open-mouth size of the eater. Accordingly, the pipe-burger has a kid-size and an adult-size for the eater to pick corresponding to the open-mouth size thereof such that the eater is able to eat the pipe-burger messy-free manner.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of manufacturing a pipe-burger, comprising the steps of:
(a) mixing a predetermined amount of texture-rich meat with flavoring ingredients to form a burger meat;
(b) extruding said burger meat into a tubular pipe mold to form an elongated pipe-burger meat in a skinless manner;
(c) cooking said elongated pip-burger meat to form a cooked pipe-burger meat with coarse fiber;
(d) providing a burger bun having an elongated burger cavity which is corresponding to said cooked pipe-burger meat; and
(e) disposing said cooked pipe-burger meat into said burger cavity of said burger bun to form a burger product.

2. The method, as recited in claim 1, wherein said step (a) comprises the steps of:
(a.1) grinding a predetermined amount of raw meat into said texture-rich meat so as to keep an original texture and tender of said raw meat; and
(a.2) adding said flavoring ingredients into said texture-rich meat for enhancing a taste and nutrition value of said cooked pipe-burger meat, wherein said flavoring ingredients comprises natural spice, salt and natural juice.

3. The method, as recited in claim 1, wherein said burger meat is directly extruded into said tubular pipe mold to retain said pipe-burger meat in an elongated structure so as to eliminate a casing for said burger meat stuffing thereinto.

4. The method, as recited in claim 2, wherein said burger meat is directly extruded into said tubular pipe mold to retain said pipe-burger meat in an elongated structure so as to eliminate a casing for said burger meat stuffing thereinto.

5. The method, as recited in claim 1, wherein said step (a) further comprises a preserving step of mixing said burger meat with natural anti-oxidation agent as a preservative agent to preserve said burger meat in a healthier manner.

6. The method, as recited in claim 2, wherein said step (a) further comprises a preserving step of mixing said burger meat with natural anti-oxidation agent as a preservative agent to preserve said burger meat in a healthier manner.

7. The method, as recited in claim 4, wherein said step (a) further comprises a preserving step of mixing said burger meat with natural anti-oxidation agent as a preservative agent to preserve said burger meat in a healthier manner.

8. The method as recited in claim 1 wherein, in said step (c), said pipe-burger meat is grilled to form said cooked pipe-burger meat, having a diameter with a range from 0.5 to 2 inches, to keep said coarse fiber thereof, wherein said burger product has a circumferential size smaller than an open mouth size of an eater.

9. The method as recited in claim 4 wherein, in said step (c), said pipe-burger meat is grilled to form said cooked pipe-burger meat, having a diameter with a range from 0.5 to 2 inches, to keep said coarse fiber thereof, wherein said burger product has a circumferential size smaller than an open mouth size of an eater.

10. The method as recited in claim 7 wherein, in said step (c), said pipe-burger meat is grilled to form said cooked pipe-burger meat, having a diameter with a range from 0.5 to 2 inches, to keep said coarse fiber thereof, wherein said burger product has a circumferential size smaller than an open mouth size of an eater.

11. The method, as recited in claim 1, wherein after said step (b), further comprises the steps of:
(b.1) pre-cooking said pipe-burger meat for safety purpose;
(b.2) vacuum-packing said pipe-burger meat in a sealing bag to eliminate bacteria and germs in the vicinity of said pipe-burger meat; and
(b.3) keeping said pipe-burger meat in a sealing bag under a predetermined temperature to keep a freshness of said pipe-burger meat.

12. The method, as recited in claim 7, wherein after said step (b), further comprises the steps of:
(b.1) pre-cooking said pipe-burger meat for safety purpose;
(b.2) vacuum-packing said pipe-burger meat in a sealing bag to eliminate bacteria and germs in the vicinity of said pipe-burger meat; and
(b.3) keeping said pipe-burger meat in a sealing bag under a predetermined temperature to keep a freshness of said pipe-burger meat.

13. The method, as recited in claim 10, wherein after said step (b), further comprises the steps of:
(b.1) pre-cooking said pipe-burger meat for safety purpose;
(b.2) vacuum-packing said pipe-burger meat in a sealing bag to eliminate bacteria and germs in the vicinity of said pipe-burger meat; and
(b.3) keeping said pipe-burger meat in a sealing bag under a predetermined temperature to keep a freshness of said pipe-burger meat.

14. A pipe-burger for a burger product, comprising an elongated pipe-burger meat in a skinless manner, wherein said pipe-burger meat, having a diameter corresponding a mouth size of an eater, is made of texture-rich meat having coarse fiber with flavoring ingredients, wherein said texture-rich meat is mixed with said flavoring ingredients to from a burger meat and said burger meat is made is extruded to from said elongated pipe-burger meat in a skinless manner, wherein said elongated pip-burger meat is cooked to form a cooked pipe-burger meat with coarse fiber, such that said cooked pipe-burger meat is disposed in an elongated burger cavity of a burger bun to form said burger product having a circumferential size smaller than an open mouth size of an eater.

15. The pipe-burger, as recited in claim 14, wherein said pipe-burger meat has an outer coarse surface when said pipe-burger meat is grilled.

16. The pipe-burger, as recited in claim 15, wherein said flavoring ingredients comprises natural spice, salt and natural juice, wherein said meat is selected from the group consisting of beef, chicken, turkey, and salmon.

17. The pipe-burger, as recited in claim 16, further comprising a natural anti-oxidation agent as a preservative agent mixing with said pipe-burger meat to preserve said burger meat in a healthier manner.

18. The pipe-burger, as recited in claim 17, wherein said pipe-burger meat is extruded to form an elongated structure for eliminating a casing for said pipe-burger meat stuffing thereinto.

19. The pipe-burger, as recited in claim 14, wherein said flavoring ingredients comprises natural spice, salt and natural juice, wherein said meat is a green meat made of vegetable and soy bean.

20. The pipe-burger, as recited in claim 19, wherein said pipe-burger meat is extruded to form an elongated structure for eliminating a casing for said pipe-burger meat stuffing thereinto.
